(19) United States
(12) Patent Application Publication
(10) Pub. No.: US 2008/0035703 A1
(43) Pub. Date: Feb. 14, 2008

(54) Oxidation resistant solder preform

(76) Inventors: Daewoong Suh, Phoenix, AZ (US); Jessica Weninger, Chandler, AZ (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/502,057

(22) Filed: Aug. 9, 2006

(51) Int. Cl. B23K 35/14; B23K 35/12

(52) U.S. Cl. 228/56.3; 228/246

(57) ABSTRACT

A solder preform includes a solder material, a diffusion barrier disposed adjacent to a surface of the solder material, and an oxidation barrier disposed adjacent to the diffusion barrier wherein the diffusion barrier is interposed between the solder material and the oxidation barrier. The solder preform can be disposed adjacent to a bonding surface of a thermal component, and the solder material heated at least to its melting temperature and then cooled below its melting temperature, bonding the solder material with the bonding surface of the thermal component. A flux-free bonding interface can be maintained between the thermal component and the solder preform.

### FIELD OF THE INVENTION

The invention relates generally to the field of semiconductor device manufacturing. In particular, the invention relates to thermal interface materials for reducing void formation during bonding.

### BACKGROUND OF THE INVENTION

Many solder materials are susceptible to oxidation, particularly at elevated temperatures used during solder reflow. Oxidation at the interface between a solder material and a bonding surface interferes with the wetting of the surface by the solder, and therefore interferes with the formation of a strong bond between the solder and the surface. Commonly, oxidation leads to void formation in the bond interface, indicating the complete absence of a bond in an area coextensive with the void. Weak bonds, including those with voids, frequently fail during testing or normal use, and represent a significant reliability problem.

Flux materials, such as an acid flux as one example, are commonly used to prevent or minimize oxidation during solder bonding, and to promote adequate wetting and the formation of strong solder bonds. However, flux residues and by-products also represent a significant cause of void formation in solder bonds. In many conventional solder bonds, such as between a solder thermal interface material (TIM) and an integrated circuit device, some small voids can be tolerated. Generally, this is because, although they degrade the thermal transfer efficiency between the integrated circuit device and the solder TIM to a small extent, the voids represent a relatively small portion of the overall bond line area. Therefore, they do not generally pose a substantial danger of causing device failure. However, in thin TIM applications, there is far less solder TIM thickness available to accommodate voids caused by flux residues and by-products. Therefore, voids tend to spread laterally throughout the bond line, comprising a significant portion of the overall bond line area, and greatly interfering with thermal transfer away from thermal device such as an integrated circuit device. As a result, voids in thin TIM applications caused by flux residues and by-products represent a far more significant risk for device failure due to excess thermal buildup.

One approach to prevent flux residues and byproducts from interfering with the formation of strong, reliable solder bonds is to reflow the solder in a vacuum oven, wherein a pressure drop down to approximately 300 Torr for approximately 3 seconds relatively effectively removes flux byproducts and entrapped air from the solder bond area immediately prior to bond formation. However, vacuum ovens do not provide adequately rapid throughput time to support high volume manufacturing, and purchasing a sufficient number of ovens is cost, space, and resource prohibitive.

Fluxless bonding has been attempted by coating a solder material with a noble metal, such as gold, to prevent oxidation of the solder material, such as indium. This approach, however, suffers from the fact that gold and other noble metals diffuse extremely rapidly into group III or IV metals, such as indium, tin, and lead. In the case of gold, such diffusion leads to the formation of a gold-indium (AuIn₂) intermetallic compound, which is far less inert than gold, and leads to poor wetting, and hence, formation of weak, unreliable bonds. Therefore, coating a solder material with a noble metal has not proven to be a sufficiently beneficial approach.

### BRIEF DESCRIPTION OF THE DRAWINGS

FIG. 1 depicts a method for forming a solder preform according to an embodiment of the invention.

FIG. 2 depicts a cross-sectional view of a solder preform according to an embodiment of the invention.

FIG. 3 depicts a cross-sectional view of a solder preform according to an embodiment of the invention.

FIG. 4 depicts a cross-sectional view of a solder preform according to an embodiment of the invention.

FIG. 5 depicts a cross-sectional view of a solder preform according to an embodiment of the invention.

FIG. 6 depicts a cross-sectional view of a solder preform according to an embodiment of the invention.

FIG. 7 depicts a cross-sectional view of a solder preform according to an embodiment of the invention.

FIG. 8 depicts a method of bonding using a solder preform according to an embodiment of the invention.

FIG. 9 depicts a cross-sectional view of a solder preform disposed adjacent to a plurality of thermal components according to an embodiment of the invention.

FIG. 10 depicts a cross-sectional view of an assembly including a solder TIM according to an embodiment of the invention.

### DETAILED DESCRIPTION OF THE INVENTION

For clarity and simplicity throughout this description, an example embodiment of a solder preform as a solder thermal interface material (TIM) is described, although it should be clear that the embodiments are not so limited. An effective thermal interface material establishes an intimate thermal coupling with a surface of a thermal component so that heat is efficiently conducted either from the thermal component to the TIM, or from the TIM to the thermal component. In general, a TIM serves as a thermal bridge between a thermal component from which thermal energy is to be removed, and a thermal component to which the thermal energy is to be conveyed. Regarding many of the embodiments described herein, the thermal component from which thermal energy is to be removed is an integrated circuit device, for example a semiconductor chip (die). In some embodiments, however, the thermal component from which thermal energy is to be removed is a passive cooling device, for example an integral heat spreader. Likewise, in many of the described embodiments, the thermal component to which the heat is to be conveyed is either a passive cooling device, for example an integral heat spreader (IHS) or a heat sink, or an active cooling device, for example a thermoelectric cooler (TEC), a multiphase cooler, or a refrigeration device.

A solder TIM is generally preformed to define surfaces for bonding with a thermal component, and an appropriate TIM thickness for the particular application, just as other solder preforms are given shapes or configurations that make them more suitable for particular applications. To promote a strong, reliable bond and effective heat conduction across a bond line between a TIM and a thermal component, a molten TIM effectively wets an area of the surface of the thermal component corresponding to the bond line, and voids may be prevented from forming or remaining in the bond line when the TIM cools and solidifies. An oxidation barrier disposed at a surface of the solder preform and typically formed of a noble metal, may prevent oxidation of the exposed surfaces of the preform, maintaining an effective wetting condition of the solder TIM. A diffusion barrier disposed at a surface of the preform, so that it is interposed between the oxidation barrier and the preform, may prevent the oxidation barrier from diffusing into the solder material of the preform prior to reflow, therefore maintaining the anti-oxidation properties of the oxidation barrier and obviating the need for a chemical anti-oxidation agent, such as a flux material. Because a flux material is not used, voids are not formed from flux residues and by-products at the bond line between the thermal component and the solder TIM.

When the solder material of a preform reflows, the diffusion barrier and oxidation barrier substantially dissolve (completely, or nearly completely) into the solder TIM, and an intimate thermal bond is formed between the TIM and an area of a surface of the thermal component corresponding to the bond line. A flux-free (‘fluxless’, containing no or substantially no flux, flux residues, or flux by-products) bond line is maintained, providing a stronger, more reliable, and more thermally effective bond than a similar bond having voids caused by flux residues and by-products.

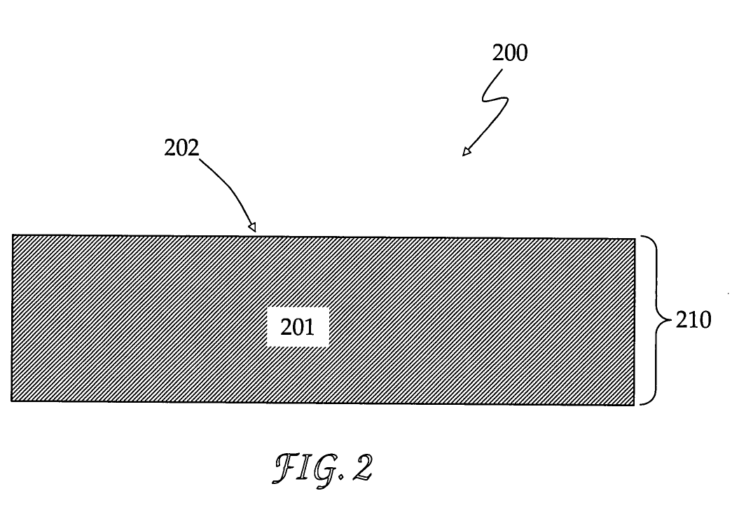

With reference to FIG. 2, preform 200 in the exemplary embodiment of a solder TIM typically includes a discrete quantity/unit of solder material 201, configured with at least one surface 202 to correspond with a bonding surface of a first thermal component, and typically but not always, at least a second surface to correspond with at least a bonding surface of a second thermal component. The surface 202 can be considered a ‘bonding surface’, as it generally corresponds with that portion of the preform 200 that bonds with a corresponding bonding surface of a thermal component following reflow and resolidification of the solder TIM. Occasionally, a single surface of a preform will correspond with bonding surfaces of more than one thermal component, such as multiple semiconductor die disposed in close proximity. A solder preform also is generally configured with thickness 210 that corresponds with and/or defines a gap between a bonding surface of a first thermal component and a bonding surface of at least a second thermal component. For example, a preform having thickness 210 of approximately 500 μ (microns) or less is typical, however, the embodiments are not so limited, and a preform can also be formed with thickness 210 greater than approximately 500 μ.

The solder material 201 of the preform can include any number of thermally conductive, reflowable materials, including but not limited to such relatively low melting temperature metals as tin, indium, and/or the numerous alloys of each. Although we refer to a ‘solder TIM’ or a ‘solder material’ throughout this description, the embodiments are not so limited, and includes preforms formed of thermally conductive, reflowable materials. In particular, however, TIM materials that are highly susceptible to oxidation are most likely to benefit from the embodiments described, or reasonably understood by implication from the descriptions provided herein. Additionally, solder preforms for use in other applications are also included among the embodiments. A non-exclusive list of other such solder preforms includes solder ‘wire’, such as may be coiled and sequentially used over an extended period of time, solder ingots, or solder ‘bumps’ or ‘pads’ disposed at the surface of a substrate, such as for establishing electrical connections. In general, a solder preform is a quantity of solder in solid phase configured and/or disposed for reflow and re-solidification at a later time, typically to form a bond with at least a first surface. A solder preform could also simply include a quantity of solder material configured for convenient storage and/or handling, where prevention of oxidation is intended and/or beneficial.

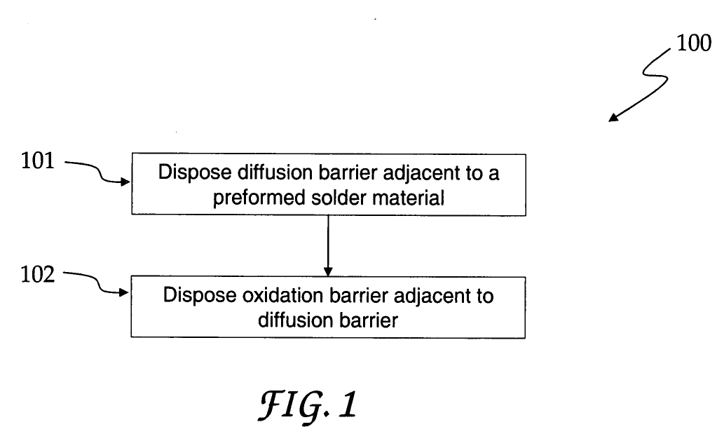

Referring to the embodiment of FIG. 1 at 101, diffusion barrier 303 is disposed adjacent to the surface 202 of the solder material 301 of the preform 300. A diffusion barrier prevents diffusion of an oxidation barrier material into the solder material 301, and is formed of, for example, nickel, titanium, tantalum, tungsten, platinum, palladium, or some combination thereof. Disposing diffusion barrier 303 is accomplished through such methods as sputtering, evaporation, or ion plating. In the case of nickel, platinum, and palladium, in particular, methods such as electroplating and/or electroless plating are also useful for disposing the diffusion barrier materials.

Diffusion barrier 303 should generally be thick enough to prevent migration of an oxidation barrier material into the solder material 301 prior to reflow, while also being thin enough to substantially dissolve into the solder material 301 during reflow of the solder TIM. For example, a diffusion barrier material with a weight percent comprising approximately 0.5% of an indium preform, and having a similar density (e.g. palladium), will have a thickness relative to the indium preform of approximately 1/200. This thickness ratio is in a range sufficient to ensure adequate dissolution of the diffusion barrier 303 into the indium preform. Although different diffusion barrier materials will have different densities and different dissolution rates into different solder preform materials, appropriate thickness ranges can be determined for each diffusion barrier/preform material combination through relatively simple experimentation. As expected, diffusion barrier 303 is generally formed as a thin layer having surface 304 which is relatively conformal with the surface 202 of the solder material 301.

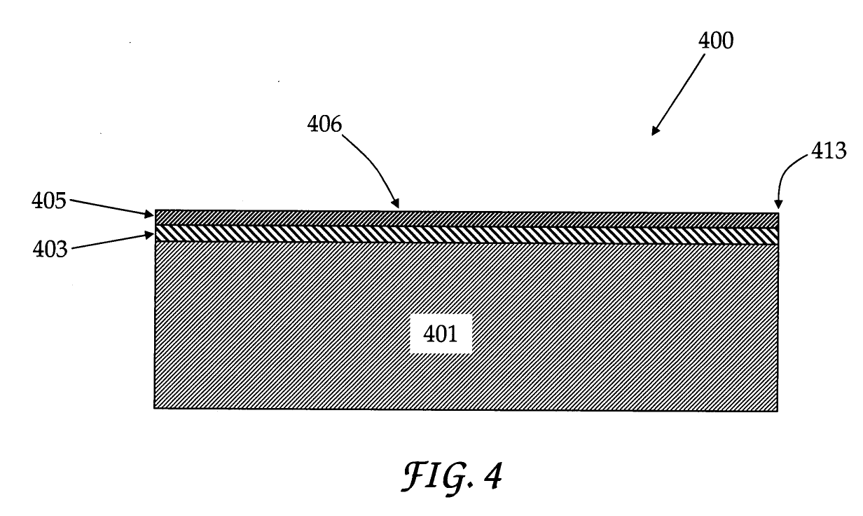

Generally, and with reference to FIG. 1 at 102, and FIG. 4, following disposition of a diffusion barrier 403, oxidation barrier 405 is disposed adjacent the surface 304 of the diffusion barrier 403. As with the diffusion barrier 403, the oxidation barrier 405 is generally formed as a thin layer having surface 406 that is relatively conformal with the surfaces of both the solder material 401 and the diffusion barrier 403. And as with the diffusion barrier, oxidation barrier 405 also should generally be thick enough to prevent oxidation of the solder material 301 prior to reflow, while also being thin enough to substantially dissolve into the solder material 301 during reflow of the solder TIM. The same weight percent and thickness ratio as provided above for a diffusion barrier applies likewise for an oxidation barrier. Oxidation barrier 405 is generally formed of a noble metal, for example gold, silver, rhodium, iridium, osmium, ruthenium or some combination thereof, and prevents oxidation from forming at a surface of the solder material 401 protected by the oxidation barrier 405. The embodiments of oxidation barrier 405 are not limited to those materials specifically listed here, and may include other materials similarly capable of slowing or preventing oxidation of solder material 401.

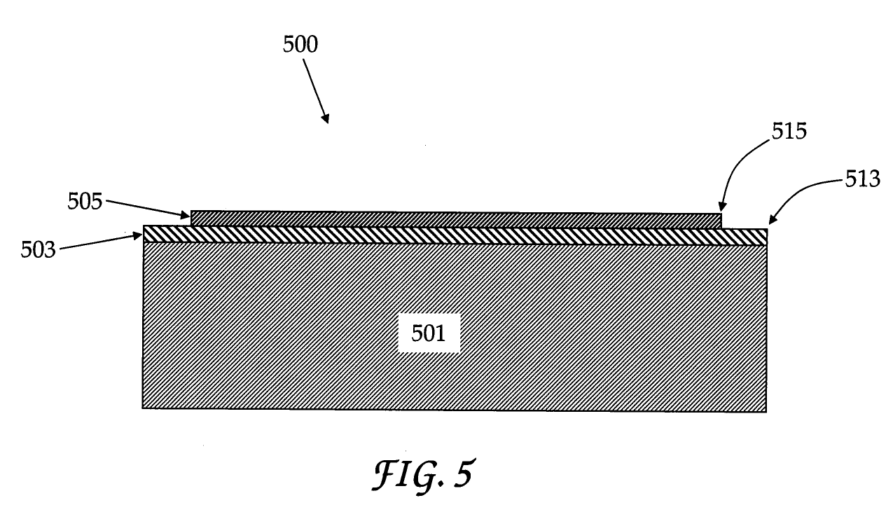

As the diffusion barrier 403 provides benefits by preventing the oxidation barrier 405 from diffusing into the solder material 401, the diffusion barrier 403 is generally interposed between the oxidation barrier 405 and the solder material 401 across a large portion of surface 202 of the preform 400. In some instances, the extent of the oxidation barrier 405 relative to a surface of the solder material 401, as defined by the relative positions of one or more of the boundary edges 413, is coextensive with the diffusion barrier 403. Therefore, the material of the oxidation barrier 405 does not come into contact with the solder material 401, avoiding formation of an intermetallic compound from the material of the oxidation barrier 405 and the solder material 401. In other instances, as with the preform 500 depicted in FIG. 5, the boundaries 515 of the oxidation barrier 505 are less than coextensive with the boundaries 513 of the diffusion barrier, and as above, the material of the oxidation barrier 505 does not come into contact with the solder material 501. In some instances, the boundaries of the oxidation barrier may extend beyond the boundaries of the diffusion barrier and directly contact the solder material, however, this is typically only allowed where the overextending portion of the oxidation barrier is located at, near, or outside the periphery of the preform surface portion corresponding to a bonding surface of a thermal component.

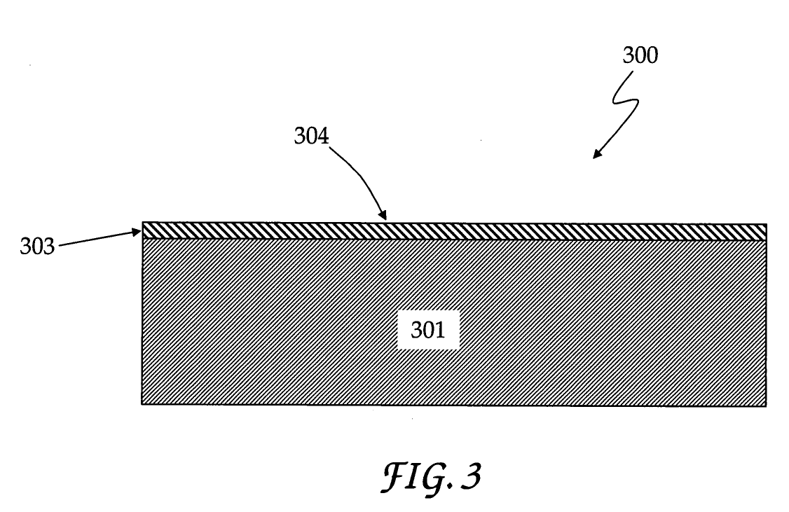

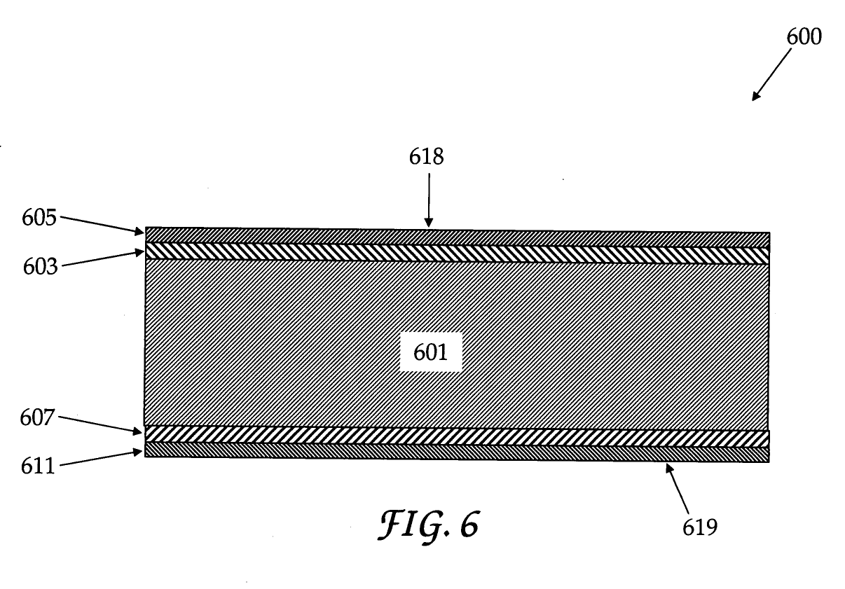

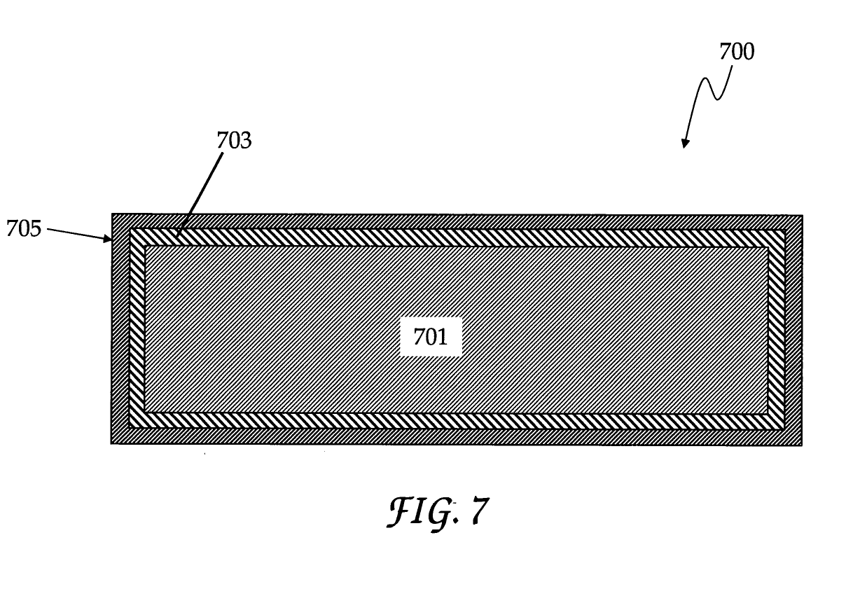

As previously mentioned, a solder preform typically has at least a second surface to correspond with at least a second thermal component. As depicted by the embodiment shown in FIG. 6, preform 600 is configured with first diffusion barrier 603 and first oxidation barrier 605 disposed at first surface 618 of solder material 601, and second diffusion barrier 607 and second oxidation barrier 611 disposed at second surface 619. However, even more effectively, the solder material 701 of preform 700, as depicted in the embodiment of FIG. 7, can be substantially enclosed within diffusion barrier 703 and oxidation barrier 705, leaving little or no solder material 701 exposed to the ambient atmosphere. Although FIGS. 1-7 depict a solder preform having a rectangular cross-section, the embodiments are not so limited, and other cross-sectional shapes are included within the inventive scope according to alternative embodiments.

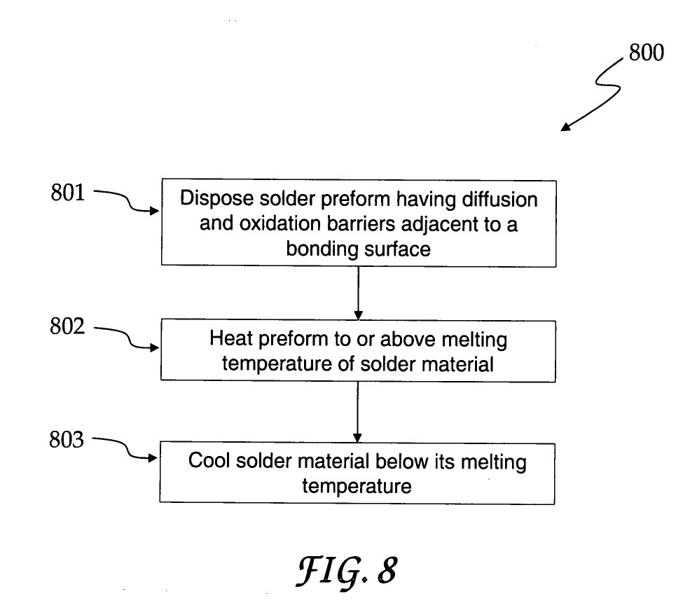

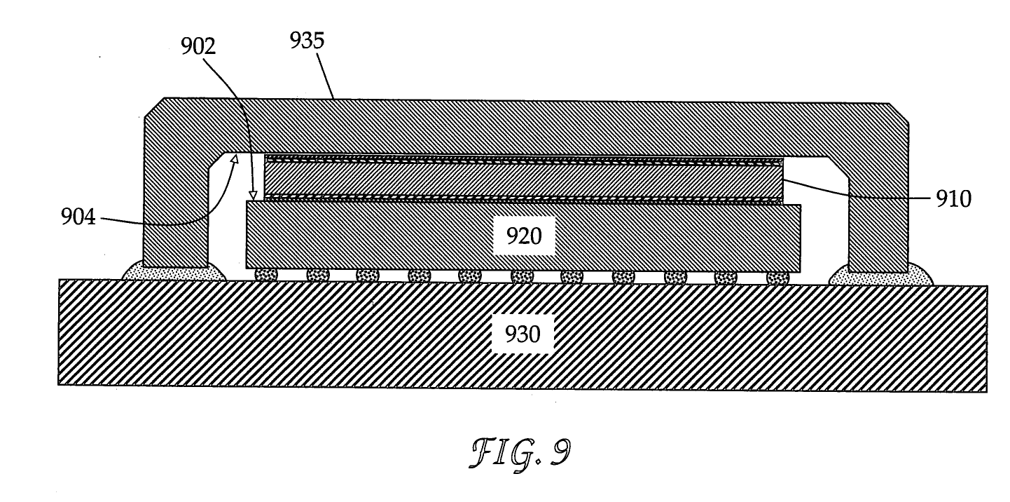

FIG. 8 depicts an embodiment wherein, at 801, a first surface of solder preform 910 protected by a diffusion barrier and an oxidation barrier, also depicted in FIG. 9, is disposed adjacent to a first bonding surface, such as surface 902 of first thermal component 920 (e.g., an integrated circuit device). Further, a second surface of the preform 910 is disposed adjacent to a second bonding surface, such as surface 904 of second thermal component 935, (e.g., an IHS). In the depicted embodiment, either one or both of the first thermal component 920 and the second thermal component 935 is physically coupled with substrate 930, for example a printed circuit substrate, in some embodiments, while in others, neither of the first and second thermal components are physically coupled with substrate 930. In other embodiments, a directional compressive force is applied that causes a surface(s) of the preform 910 to be brought into even closer contact with the corresponding surfaces of the thermal component(s). In some instances, a directional compressive force is sufficiently strong to deform a malleable solder material of a preform. In embodiments wherein the solder preform is a solder foil, wire, rod, ingot, or other configuration, the first and second bonding surfaces can include surfaces of nearly any items which can be wetted with a molten solder material and physically coupled with a solidified solder material. For ease of description herein, the example embodiments of bonding surfaces of a first and second thermal device are used.

Referring once more to FIG. 9 and to FIG. 8 at 802, the preform 910 disposed directly adjacent to a bonding surface of at least first thermal component 920, is heated at least to the melting temperature of the solder material, causing the solder material to melt and reflow across the bonding surface of the first thermal component 920. As the solder material melts, both the diffusion barrier and the oxidation barrier substantially dissolve into the solder material. The surface of the molten solder material remains relatively free from oxidation in the areas corresponding to the bond line between the solder material and the thermal component(s), and the solder material effectively wets the surface of the thermal component(s). The absence of flux materials in the bond line avoids flux residues or by-products forming voids, and allows the molten solder material to wet substantially all of the bonding surface of the thermal component in the area corresponding to the bond line.

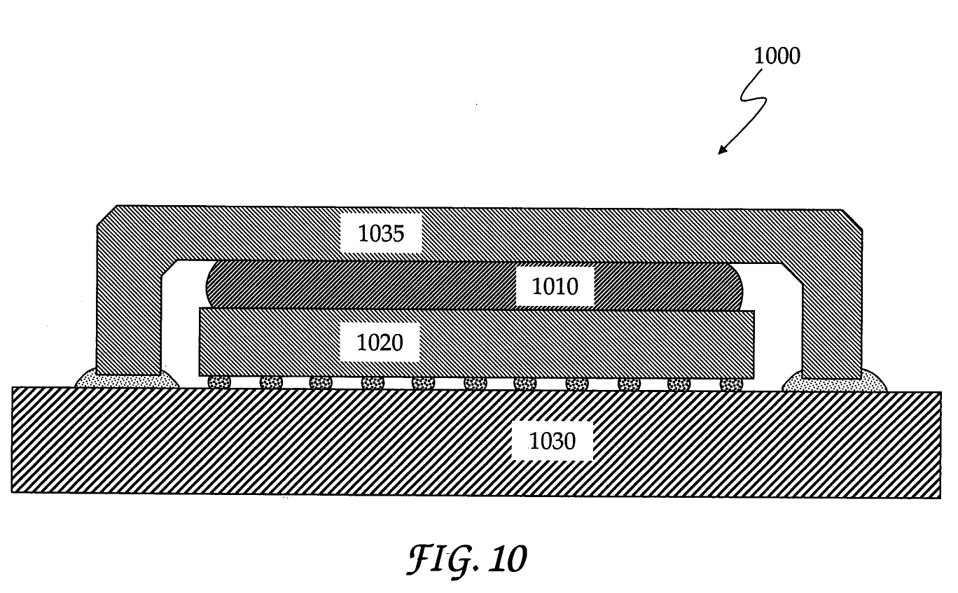

Referring to FIG. 8 at 803, and the embodiment depicted in FIG. 10, the solder material 1010 is cooled below its melting temperature and solidifies, forming a relatively strong bond along a bond line with each thermal component, such as the first thermal component 1020 and the second thermal component 1035. The absence of flux material along a bond line is maintained, and because voids typical of flux residues and by-products are avoided, an efficient and effective thermal interface is formed at a bond line between each thermal component and the solder TIM.

As can also be seen in FIG. 10, assembly 1000 is formed including a plurality of thermal components, at least one of which is an integrated circuit device (IC chip) 1020, and at least another of which is a cooling device 1035. Interposed between the IC chip 1020 and cooling device 1035 is thermal interface material 1010 having relatively strong bonds with a surface of each of the IC chip 1020 and the cooling device 1035. Further, at least one of the IC chip 1020 and/or the cooling device 1035 is physically coupled with printed circuit substrate 1030. Examples of printed circuit boards according to alternate embodiments include a motherboard of a computer system or server system, a circuit board of an audio or video/graphics system, or a circuit board of a system designed for measurement and/or signal detection. The bond line between the TIM 1010 and each thermal component is maintained free from flux materials, including flux residues and flux by-products. The TIM 1010 includes a dissolved oxidation barrier material, including at least one of gold, silver, rhodium, iridium, osmium, and ruthenium, and further includes a dissolved diffusion barrier material, including at least one of nickel, titanium, tantalum, tungsten, platinum, and palladium.

As described herein, an oxidation resistant solder preform configured and applied as a solder TIM can be reflowed to form a strong bond with a bonding surface of a thermal component. In alternative embodiments, other types of oxidation resistant solder preforms can likewise be reflowed to form bonds with surfaces. For example, a solder wire (or ‘cord’, or ‘rod’, or other easily handled solder preform) can be used to form a bond with a surface, to form a bond between two surfaces or items (e.g., to join two electrical wires), or to form a bond between a wide variety of item, far too numerous to list herein. Likewise, a solder material can be bonded with an item or surface, and subsequently, a diffusion barrier and an oxidation barrier can be disposed at the remaining exposed surfaces of the solder material as described herein, thus maintaining all remaining exposed surfaces of the solder material in an oxidation resistant condition.

The foregoing detailed description and accompanying drawings are only illustrative and not restrictive. They have been provided primarily for a clear and comprehensive understanding of the embodiments of the invention, and no unnecessary limitations are to be understood therefrom. Numerous additions, deletions, and modifications to the embodiments described herein, as well as alternative arrangements, may be devised by those skilled in the art without departing from the spirit of the embodiments and the scope of the appended claims.

We claim:

1. A solder preform, comprising:
a solder material;
a first diffusion barrier disposed adjacent to a first surface of the solder material; and
a first oxidation barrier disposed adjacent to a surface of the diffusion barrier, wherein the first diffusion barrier is interposed between the first surface of the solder material and the first oxidation barrier.

2. The solder preform of claim 1, wherein the solder material comprises indium.

3. The solder preform of claim 1, wherein the first diffusion barrier comprises at least one material selected from the group consisting of nickel, titanium, tantalum, tungsten, platinum, and palladium.

4. The solder preform of claim 1, wherein the first oxidation barrier comprises at least one material selected from the group consisting of gold, silver, rhodium, iridium, osmium, and ruthenium.

5. The solder preform of claim 1, wherein the thickness of the solder preform is less than approximately 500 microns.

6. The solder preform of claim 1, wherein the first diffusion barrier comprises a layer with a thickness of less than approximately 0.1 micron.

7. The solder preform of claim 1, wherein the first oxidation barrier comprises a layer with a thickness of less than approximately 0.1 micron.

8. The solder preform of claim 1, further comprising at least a second diffusion barrier and at least a second oxidation barrier disposed adjacent to at least a second surface of the solder material, wherein the second diffusion barrier is interposed between the second surface of the solder material and the second oxidation barrier.

9. The solder preform of claim 1, wherein the extent of the disposed first oxidation barrier relative to the first surface of the solder material is no greater than coextensive with the first diffusion barrier.

10. A method, comprising:
disposing a solder preform adjacent to a first bonding surface, the preform comprising,
a solder material,
a first diffusion barrier disposed adjacent to a first surface of the solder material; and
a first oxidation barrier disposed adjacent to a first surface of the first diffusion barrier, wherein the first diffusion barrier is interposed between the first surface of the solder material and the first oxidation barrier, and the oxidation barrier is interposed between the first surface of the first diffusion barrier and the first bonding surface;
heating the preform to at least the melting temperature of the solder material; and
cooling the solder material below its melting temperature and bonding the solder material with the first bonding surface.

11. The method of claim 10, wherein the solder preform is interposed between the first bonding surface and at least a second bonding surface.

12. The method of claim 11, further comprising at least a second diffusion barrier and a second oxidation barrier interposed between a second surface of the solder material of the preform and the first bonding surface, wherein the second diffusion barrier is interposed between the second surface of the solder material and the second oxidation barrier.

13. The method of claim 11, wherein at least one of the first and second bonding surfaces is a surface of a thermal component selected from the group consisting of an integrated circuit device, a passive cooling device, and an active cooling device.

14. The method of claim 10, wherein the first diffusion barrier and the first oxidation barrier substantially dissolve into the molten solder material.

15. The method of claim 10, wherein the solder material comprises indium.

16. The method of claim 10, wherein the first diffusion barrier comprises at least one material selected from the group consisting of nickel, titanium, tantalum, tungsten, platinum, and palladium.

17. The method of claim 10, wherein the first oxidation barrier comprises at least one material selected from the group consisting of gold, silver, rhodium, iridium, osmium, and ruthenium.

18. The method of claim 10, further comprising maintaining a flux-free interface area between the solder preform and the first bonding surface.

19. A method, comprising:
disposing a first diffusion barrier at a first surface of a preformed solder material; and
disposing a first oxidation barrier at a first surface of the first diffusion barrier, the diffusion barrier being interposed between the first surface of the solder material and the first oxidation barrier.

20. The method of claim 19, wherein the first diffusion barrier comprises at least one material selected from the group consisting of nickel, titanium, tantalum, tungsten, platinum, and palladium.

21. The method of claim 19, wherein the first oxidation barrier comprises at least one material selected from the group consisting of gold, silver, rhodium, iridium, osmium, and ruthenium.

22. An assembly, comprising:
a printed circuit substrate of a computer system;
a plurality of thermal components, at least one of the thermal components physically coupled with the substrate; and
a thermal interface material (TIM) interposed between at least one of the plurality of thermal components and at least another of the plurality of thermal components, the TIM forming a relatively strong bond along a bond line with a surface of each of the thermal components, the TIM further including a dissolved diffusion barrier material and a dissolved oxidation barrier material.

23. The assembly of claim 22, wherein the diffusion barrier material comprises at least one material selected from the group consisting of nickel, titanium, tantalum, tungsten, platinum, and palladium, and the oxidation barrier material comprises at least one material selected from the group consisting of gold, silver, rhodium, iridium, osmium, and ruthenium.

24. The assembly of claim 22, wherein the bond line is flux-free.
